(19) United States
(12) Patent Application Publication
(10) Pub. No.: US 2026/0285515 A1
(43) Pub. Date: Sep. 24, 2026

(54) Drone in a Box

(71) Applicant: XCEL ENERGY INC., Minneapolis, MN (US)

(72) Inventors: Thomas S. STEGGE, Wyoming, MN (US); Zachary Taylor ROACH, Parker, CO (US); Steven Anthony BELL, Minneapolis, MN (US)

(21) Appl. No.: 19/079,194

(22) Filed: Mar. 13, 2025

Related U.S. Application Data
(60) Provisional application No. 63/565,863, filed on Mar. 15, 2024.

(51) Int. Cl. B64U 80/25; B64U 50/31; B64U 70/50; B64U 80/30; B64U 80/70; B64U 80/82

(52) U.S. Cl. CPC B64U 80/25; B64U 50/31; B64U 70/50; B64U 80/30; B64U 80/70; B64U 80/82; B64U 2201/20

(57) ABSTRACT

Disclosed is a self-sustainable trailer for deploying an unmanned aerial vehicle (UAV) at a site for an extended period of time. The trailer can include: a power supply system to generate, store, and provide power to trailer components, the power supply system including a battery and solar panels, at least one sensor to generate signals indicating ambient conditions proximate the trailer, a railing attached along a perimeter of the trailer to enclose an area where a UAV takes off and touches down, a network communication interface to provide wireless communication amongst the trailer components and the UAV, and a controller in communication, via the network communication interface, with the trailer components and the UAV. The controller can receive the signals from the sensor, and generate and execute, based on processing the signals, instructions to control the trailer components and the UAV while on site for the extended period of time.

### INCORPORATION BY REFERENCE

This application claims the benefit of U.S. Provisional Patent Application No. 63/565,863, filed Mar. 15, 2024, which is incorporated herein by reference in its entirety.

### TECHNICAL FIELD

This disclosure generally describes devices, systems, and methods related for self-sustaining and portable drone storage, operations, and deployment.

### BACKGROUND

Drones, and other types of unmanned aerial vehicles (UAVs) can be used in the energy sector to perform operations that may otherwise be human-labor-intensive and costly. Drone imagery and drone-collected data can be used to measure and assess health of operations to quickly pinpoint potential issues and develop solutions. Such analysis can be performed with regard to hazardous asset inspections, such as transmission towers and substations. Sometimes, the drones may be used to reduce time it takes to investigate damage from storm-related power outages. High-resolution aerial inspections may also allow for the energy sector to analyze vegetation growth that may interfere with nearby solar panels or other energy equipment. The drones can otherwise provide for more frequent inspection of various assets (e.g., wind turbines).

The drones can be deployed to various different locations and sites for varying periods of time. The drones can be brought in to the locations and sides on trucks or other similar vehicles. The drones can be operated by humans that are onsite. Sometimes, the drones can be operated remotely by humans. In some implementations, the drones can be automatically operated without human intervention. The drones can sometimes be deployed to the locations and sites in containers. The containers can be large and/or heavy. Sometimes, the containers may require an almost permanent installation, such as a concrete pad, to secure the container in a location of deployment, regardless of a duration of time that the drone(s) may be needed at that location of deployment.

### SUMMARY

The disclosure generally describes technology for self-sustaining and portable drone storage and deployment. The disclosed technology can house one or more UAVs, such as a drone, on site, program automatic pre-flight checks and routine flights, and re-charge while ensuring protection from external factors and/or weather conditions of the drone and components of a trailer housing the drone and the components during on site deployment. More specifically, the trailer can be a flat-deck trailer having one or more weather-tight storage containers for housing the components and the drone. The trailer can sometimes include one or more components for monitoring and reporting weather conditions, an antenna system (e.g., C2 antenna), one or more receiver systems (e.g., ADSB-in receiver), at least one light, and at least one camera. The trailer can include a power supply system, which may include one or more solar panels attached to mounting racks. The mounting racks can be rotatable and configured to move in operational and travel modes for ease of use and setup. Sometimes, the power supply system can additionally or alternatively include a battery power system and/or at least one generator (e.g., gas, diesel, hydrogen). The trailer may also include one or more deployment ramps and automated doors for allowing movement of a drone into and out of the trailer. Sometimes, the trailer can include handrails, fencing, and/or any other type of railing that can be configured to secure the drone and/or other components that are part of the trailer. Any combination of these features can provide a self-sustaining and portable system for deploying drones at sites and leaving the drones at those sites for extended periods of time (e.g., 3-6 months).

One or more embodiments described herein can include a self-sustainable trailer for deploying an unmanned aerial vehicle (UAV) at a site for an extended period of time, the self-sustainable trailer including: a power supply system that can be configured to generate, store, and provide power to components of the self-sustainable trailer, the power supply system including a battery and a group of solar panels, at least one sensor that can be configured to generate signals indicating ambient conditions proximate the self-sustainable trailer, a railing attached along a perimeter of the self-sustainable trailer, the railing enclosing an area where a UAV can be configured to take off and touch down, a network communication interface that can be configured to provide wireless communication amongst components of the self-sustainable trailer and the UAV, and a controller in communication, via the network communication interface, with the components of the self-sustainable trailer and the UAV. The controller can be configured to perform operations that may include: receiving the signals generated by the at least one sensor, generating and executing, based on processing the signals, instructions to cause the power supply system to provide power to a power source of the UAV to charge the UAV when the UAV is docked at the self-sustainable trailer, performing, based on processing the signals, one or more pre-flight checks before the UAV is scheduled to take off from the self-sustainable trailer, and generating and executing, based on processing the signals, instructions to control the UAV when the UAV is in flight.

In some implementations, the embodiments described herein can optionally include one or more of the following features. For example, the group of solar panels can include 9 solar panels, where sets of 3 solar panels amongst the 9 solar panels can be arranged in a vertical orientation on respective trays, the trays being attached to tracks on a top surface of the self-sustainable trailer. The trays can be configured to move along the tracks in first directions to cause the sets of 3 solar panels to extend laterally into an open position when the self-sustainable trailer is parked at a site. The trays can be configured to move along the tracks in second directions opposite the first directions to cause the sets of 3 solar panels to stack into a closed position when the self-sustainable trailer is in transit to the site or in storage. As another example, the group of solar panels can include 3 solar panels, the 3 solar panels being arranged in a lateral orientation on respective trays, the trays being attached to tracks on a top surface of the self-sustainable trailer.

The at least one sensor can include a camera, the camera being attached to a top surface of the self-sustainable trailer and that can be configured to capture image data of an area surrounding the self-sustainable trailer. The at least one sensor can include a weather sensor that can be configured to detect weather conditions at a site where the self-sustainable trailer is parked. The weather sensor can include a microclimate tracking device. The weather sensor can include a wind sensor. The weather sensor can include a cloud coverage sensor. As another example, the at least one sensor can include a proximity sensor that can be configured to detect movement surrounding the self-sustainable trailer.

The area of the self-sustaining trailer where the UAV can be configured to take off and touch down can include a landing pad. The self-sustainable trailer further can include the UAV. The wireless communication can be a satellite internet communication. The UAV can be configured to communicate with the remote computer system via the network communication interface of the self-sustainable trailer. The self-sustainable trailer further can include at least one door attached to a surface of the self-sustainable trailer and that can be configured to automatically open and close to permit the UAV to enter and exit an interior of the self-sustainable trailer. The self-sustainable trailer further can include at least one ramp aligned with the at least one door and configured to permit movement of the UAV into and out of the interior of the self-sustainable trailer.

Sometimes, the self-sustainable trailer further can include a heat, ventilation, and air conditioning unit (HVAC) that can be configured to automatically operate to cool one or more of the components of the self-sustainable trailer. The self-sustainable trailer further can include a generator that can be configured to provide a backup power supply to one or more of the components of the self-sustainable trailer. The self-sustainable trailer further can include a light that may be controllable by the controller and that can be configured to automatically activate and deactivate based on operations of one or more components of the self-sustainable trailer. The self-sustainable trailer further can include an antenna system that can be configured to provide wireless communication between the controller of the self-sustainable trailer and a controller of the UAV when the UAV is in flight. The self-sustainable trailer further can include a fire suppression system that can be configured to activate in response to a detection of an emergency at or near the self-sustainable trailer, the emergency including a fire.

Sometimes, the self-sustainable trailer further can include a weather-resistant container that houses the network communication interface, the controller, and the UAV. The weather-resistant trailer can include a door that can be configured to automatically open and close to permit the UAV to enter and exit the weather-resistant container.

In some implementations, performing, based on processing the signals, one or more pre-flight checks before the UAV is scheduled to take off from the self-sustainable trailer can include determining, based on processing the signals, whether one or more objects are proximate the self-sustainable trailer to obstruct a flight path of the UAV. Performing, based on processing the signals, one or more pre-flight checks before the UAV is scheduled to take off from the self-sustainable trailer can include determining, based on processing the signals, whether the ambient conditions indicate that weather conditions satisfy one or more flight criteria. The operations further may include modifying, based on processing the signals, one or more flight schedules for the UAV. The operations further can include generating, based on processing the signals, one or more flight schedules for the UAV. The operations further can include adjusting, based on processing the signals, a scheduling of operations performed by the components of the self-sustainable trailer.

As another example, the operations further can include: transmitting, via the network communication interface, information about operations performed by one or more of the components of the self-sustainable trailer to a remote computer system, where, in response to receiving the information, the remote computer system can be configured to present the information in a graphical user interface (GUI) display. The remote computer system can be configured to: receive user input, based on presenting the information in the GUI display, indicating one or more modifications to the operations performed by the one or more of the components of the self-sustainable trailer, and transmit, via the network communication interface, the user input to the controller of the self-sustainable trailer, where the controller can be configured to automatically execute instructions to adjust the operations based on the one or more modifications. The one or more modifications to the operations can include adjusting a time and duration at which the UAV may be charged by the battery of the power supply system. The one or more modifications to the operations can include recharging the battery of the power supply system for a predetermined period of time. The one or more modifications to the operations can include adjusting a time and duration at which the UAV may be in flight over one or more future time periods.

The operations further can include: communicating, via the network communication interface, with controllers of other self-sustainable trailers, where the controllers can be configured to (i) transmit information about respective operations performed by respective components and (ii) coordinate the respective operations performed by the respective components based on the transmitted information. The power supply system can be configurably attached to a top surface of the self-sustainable trailer. The area where the UAV can be configured to take off and touch down can be stacked on a top surface of the power supply system, and the railing can extend along a perimeter of the area on the top surface of the power supply system. The UAV can be a drone.

In some implementations, the trailer can also include containers that can be configured to house a subset of components of the self-sustainable trailer. One container amongst the containers can be configured to house the battery. The one container further can include an HVAC unit, a generator, and a fire suppression system. One container amongst the containers can be configured to house the network communication interface. The one container further can include an energy grid connection system, a power supply management system, and a fire suppression system. As another example, one container amongst the containers can be configured to house a ground-based robot, the ground-based robot being configured to be deployed, by execution of instructions from the controller, on the ground surrounding the self-sustainable trailer, to collect data on the ground, and to transmit the collected data to the controller for use in performing the operations.

One or more embodiments described herein can include a trailer for deploying a UAV at a site for an extended period of time, the trailer including: a power supply system that can be configured to generate, store, and provide power to components of the trailer, a railing attached along a perimeter of the trailer, the railing enclosing an area where a UAV can be configured to take off and touch down, a network communication interface that can be configured to provide wireless communication amongst the components of the trailer, and a controller in communication, via the network communication interface, with at least the power supply system and the UAV, the controller being configured to monitor, modify, and control one or more operations performed by components of the trailer.

The trailer can optionally include one or more of the above mentioned features. Additionally, the trailer can include one or more of the following features. The power supply system can include a battery. The power supply system can include a group of solar panels. The trailer can also include at least one sensor that can be configured to generate signals indicating ambient conditions proximate the trailer. The railing can be attached along a perimeter of the power supply system, and the area where the UAV can be configured to take off and touch down can include a top surface of the power supply system enclosed by the railing. The UAV can be a drone. Sometimes, the trailer may include the UAV.

The devices, system, and techniques described herein may provide one or more of the following advantages. For example, the disclosed techniques allow for drones to be deployed to locations in trailers that are self-sustaining for days to months, portable, and operational at low costs. A combination of features in the trailer can create self-powered autonomy that greatly reduces its deployment costs and flexibility.

Similarly, existing drone systems typically focus on storing and charging drones, but they do not integrate advanced safety, security, and sustainability features of the disclosed techniques. The disclosed techniques therefore provide technical improvements to existing systems by being capable of responding to dynamic conditions in a deployed environment. Moreover, a self-sustaining trailer can incorporate renewable energy sources (e.g., solar panels, batteries) and an advanced power management system, which enables the trailer to operate in remote locations without relying on external power grids or other external power sources. In contrast, the existing drone systems are dependent on constant external power supplies. The ability to operate autonomously and sustainably using the disclosed techniques therefore improves the technical capability of the disclosed self-sustainable trailer, thereby extending its usability in environments where power infrastructure is lacking or unavailable. The disclosed techniques therefore demonstrate technical solutions to specific problems in drone maintenance and deployment. The disclosed techniques combine different technologies (e.g., surveillance, fire safety, power management) in an integrated way to improve drone operation, security, and sustainability.

Moreover, the disclosed techniques can provide improved levels of usability and data collection capability to efficiently and accurately expand drone operations. Various sectors, including but not limited to utility, oil and gas, public safety, security, and chemical sectors can leverage the disclosed techniques. The disclosed self-sustaining drone trailer can be designed to be deployed in the field and used for various operations, including but not limited to weekly storm water pollution permit inspection on remote transmission lines, monthly large construction site progress photos/maps, daily substation monitoring in remote and/or high risk areas, wildfire risk area deployment, and/or emergency response. Various other use cases can also be possible with the design and functionality of the disclosed self-sustaining drone trailer.

The disclosed technology provides for rapid and easy deployment of assets to monitor geographic locations using a single pilot. As a result, users do not need to be deployed into the field to support every drone that is deployed, thereby providing significant costs savings and timer reduction for getting human eyes on a developing situation or performing routine operations in the field.

The disclosed technology further allows for frequent and accurate data collection. For example, in construction monitoring, a typical system may allow for drones to be deployed once a month to monitor and capture progress. Using the disclosed technology, a drone can be maintained at the site and deployed at least once a day to provide more robust data indicating granular changes in progress and development. This allows for management teams to identify more minute issues that may arise and adaptively and proactively respond and mitigate to avoid those issues growing into larger issues.

The remotely-located and deployed drones can also limit unnecessary drive time and/or call-out overtime. For example if a substation has an issue at 2 am, a worker may traditionally be called in to address the issue. The worker would have to drive to the site, which can sometimes range between 30 minutes to 2 or more hours. This can be a high risk scenario as the worker may not know what they are getting into on site (maybe fire or spilled hazardous materials or maybe nothing) plus added factors of fatigue. The disclosed technology, on the other hand, can allow for a drone on site to take flight when an issue is detected and collect data, which can be used to quickly and accurately determine whether an immediate response is really needed or whether the issue can be resolved once the worker returns to work for their shift in the morning. The drone-collected data can also be processed in real-time to determine whether additional resources may be needed to address the issue, and when those resources may be deployed. Those resources can include but are not limited to fire department personnel, police, extra materials, extra manpower, etc.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a trailer for housing a drone and related components for self-sustainable deployment of the drone.

FIG. 2A is a system diagram of one or more components of a self-sustaining trailer for a drone.

FIG. 2B is a system diagram of components that a self-sustaining trailer can communicate with.

FIG. 2C is an illustrative system diagram of a self-sustaining trailer having weather tight containers for housing components depicted in FIG. 2A.

FIGS. 3A, 3B, 3C, 3D, and 3E illustrate an example self-sustaining trailer for housing a drone.

FIG. 4 is a flowchart of a process for coordinating operations amongst a group of self-sustaining trailers housing drones.

FIG. 5 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to a self-sustaining drone system, such as a trailer, that can be mobile and moved between sites (substation, construction site, area of concern, emergency zone, etc.) to provide daily, weekly, monthly, and/or ad hoc operations without human intervention or control. The trailer described herein can include a combination of physical components that allows for a drone housed in the trailer to be mobile and self-sustaining for extended periods of time. The trailer can also include capabilities to program automatic, routine drone flights and drone safety checks, thereby eliminating a need for relevant human users to travel to the site of the drone to capture daily or weekly drone photos/data and/or perform other operations with the drone.

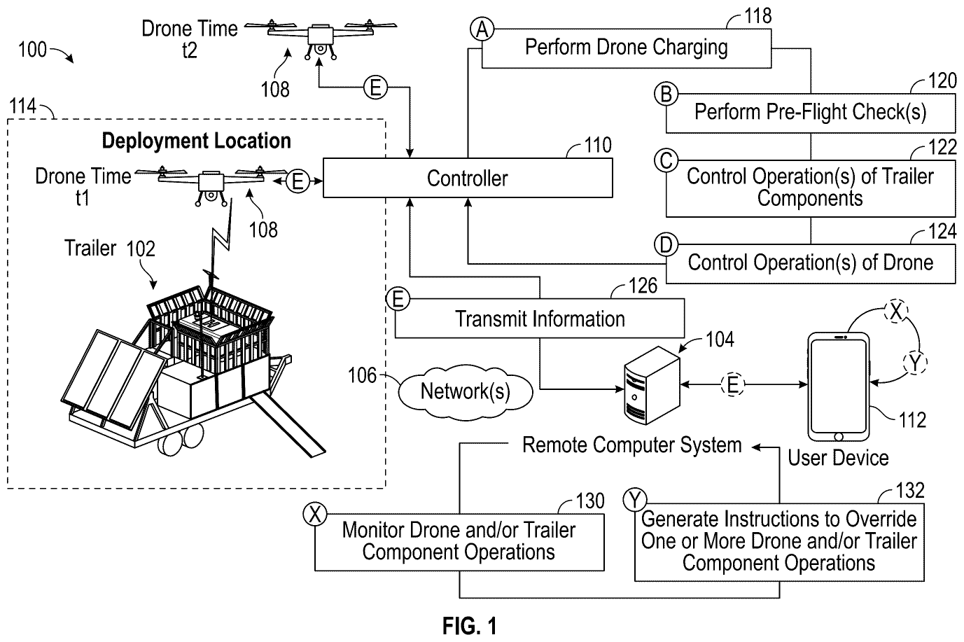

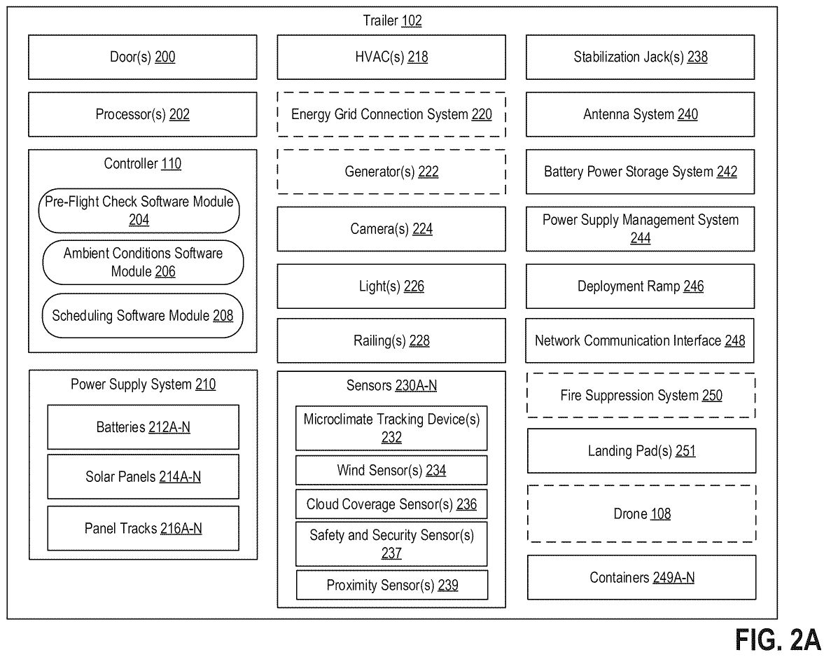

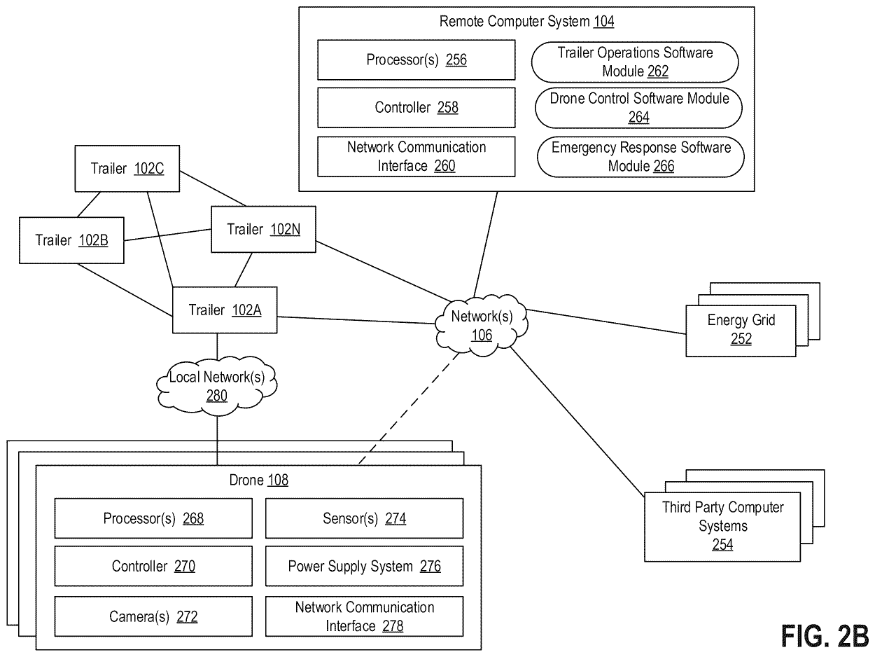

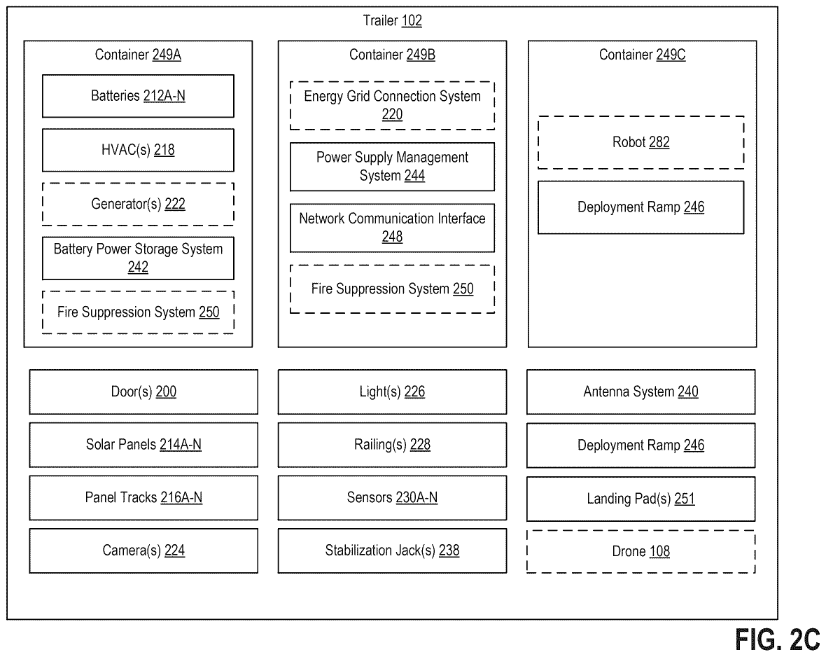

Referring to the figures, FIG. 1 is a conceptual diagram of a system 100 having a trailer 102 for housing a drone 108 and related components for self-sustainable deployment of the drone 108 at a deployment location 114. The deployment location 114 can be any type of site, including but not limited to a substation, a construction site, an emergency zone, or any other type of area of concern. The trailer 102 can include one or more physical components described further in reference to FIG. 2A that can allow for the drone 108 to be fully self-sustained at the deployment location 114 for extended periods of time (e.g., days, weeks, months). In some implementations, the trailer 102 can be brought to a physical site via a vehicle, such as a car, truck, and/or pickup truck. Sometimes, the trailer 102 can travel to the physical site with all the components of the trailer 102 set up. In some implementations, the components of the trailer 102 can be set up once the trailer 102 is situated at the physical site. As another illustrative example, the components of the trailer 102 can be arranged on a flatbed of a pickup truck. Then, the pickup truck can be left at the physical site for the duration of drone deployment. As a result, the trailer 102 may not be required.

The drone 108 can communicate with components of the trailer 102, such as a controller 110 (block E, 126), via one or more network connections established by the components of the trailer 102. The trailer 102 can include one or more systems and/or antennas (not depicted) that can be used to provide communication between the drone 108 and the controller 110. The drone 108 can communicate with the controller 110 when the drone 108 is docked at the trailer 102 and/or while the drone 108 is flying or otherwise detached from components of the controller 110. For example, at time t1, the drone 108 can be docked or otherwise within a first predetermined area of the trailer 102. The drone 108 can be charging at the trailer 102 and in communication with the controller 110. At time t2, the drone 108 can be in flight or otherwise outside of the first predetermined area of the trailer 102 (e.g., in a second predetermined area or range of the trailer 102). While the drone 108 is in flight, it can continue to communicate with the controller 110 to transmit relevant information and perform relevant operations. In some implementations, the connection between the drone 108 and the controller 110 when within the first predetermined area during time t1 can be different than the connection between the drone 108 and the controller 110 when within the second predetermined area during time t2. As an illustrative example, the drone 108 can communicate with the controller 110 via 2.4 GHz/5.8 GHz radio antenna system when in the first predetermined area. The human operator/observer can then communicate with the controller 110 via 5G and/or an internet connection provided by components of the trailer 102 when in the second predetermined area. The controller 110 can receive location data from the drone 108 and process the location data to determine a distance of the drone 108 to the trailer 102 (e.g., whether the drone 108 is in the first predetermined area, the second predetermined area, or another predetermined area of the trailer 102). Based on the distance of the drone 108 to the trailer 102, the controller 110 can determine what type of communication/connection to use and establish between the drone 108 and the controller 110.

The controller 110 can be any type of processor housed at the trailer 102 and configured to perform a multitude of operations to maintain the trailer 102 and the drone 108 as self-sustaining for extended periods of time. The controller 110 can perform operations such as performing a drone charging process (block A, 118). The controller 110 can perform operations such as performing pre-flight checks (block B, 120). The controller 110 can control one or more operations of trailer components (block C, 122). The controller 110 can control one or more operations of the drone 108 (block D, 124). The controller 110 can perform one or more of the blocks A-D (118-124). The controller 110 can perform one or more of the blocks A-D (118-124) in any order, in parallel, and/or in series. Refer to FIG. 2A for further discussion about the operations that can be performed by the controller 110.

The controller 110 may also communicate with a remote computer system 104 (or multiple remote computer systems 104) and/or a user device 112 via one or more networks 106 (e.g., wirelessly) (block E, 126). The remote computer system 104 can be any type of computing system, network of computing devices, computing device, and/or cloud-based computing system. The remote computer system 104 can be used by one or more relevant users and configured to receive information from components of the trailer 102 (e.g., the controller 110) to perform one or more additional operations. For example, the remote computer system 104 can monitor the drone 108 and/or the trailer 102 component operations (block X, 130). Additionally or alternatively, the remote computer system 104 can generate instructions to override one or more of the drone 108 and/or the trailer 102 component operations (block Y, 132). The remote computer system 104 can also communicate with the user device 112 by transmitting information from the drone 108, the controller 110, and/or other components of the trailer 102. The user device 112 can output this information in one or more graphical user interfaces (GUIs) at a display of the user device 112 for relevant users. The user device 112 can perform one or more operations, such as the operations described above in reference to blocks X and Y, 130 and 132 respectively. Refer to FIG. 2B for further discussion about the remote computer system 104 and/or the user device 112.

FIG. 2A is a system diagram of one or more components of the self-sustaining trailer 102 for the drone 108. The trailer 102 can be a platform and collection of systems for the drone 108 in a box unit to be dropped off and self-sustaining to perform daily, weekly, monthly, and/or ad hoc operations without personnel on site. The trailer 102 can be made up of one or more weather-tight storage containers to house components therein. Components and the arrangement of components in the trailer 102 can make the trailer 102 flexible and able to be moved around every couple months, such as every 3-6 months. Because the trailer 102 is self-sustaining, relocating the trailer 102 to different sites may not require time, costs, and resources associated with building and/or identifying new bases, pads, fencing boundaries, power connections, and/or network communications. Thus, the configuration of physical components of the trailer 102 can provide extended flexibility for the drone 108 to live at a short term site and then be moved and repurposed at different sites without expending significant resources. The trailer 102 can include components such as one or more doors 200, a processor 202, the controller 110, a power supply system 210, one or more Heating, ventilation, and air conditioning units 218 (HVACs), an optional energy grid connection system 220, one or more optional generators 222, one or more cameras 224, one or more lights 226, one or more railings 228, sensors 230A-N, one or more stabilization jacks 238, an antenna system 240, a battery power storage system 242, a power supply management system 244, a deployment ramp 246, a network communication interface 248, an optional fire suppression system 250, one or more landing pads 251, and/or one or more weather tight containers 249A-N. Refer to FIG. 2C for further discussion about the containers 249A-N.

The trailer 102 itself can be portable, such that a commercial driver license may not be required to move the trailer 102 between sites. Accordingly, the trailer 102 can satisfy one or more weight and/or size requirements to be pulled by a pickup truck or other vehicle that is not operated using a commercial driver license. For example, a total weight of the trailer 102 and a vehicle pulling the trailer 102 may not exceed 26,000 pounds. The trailer 102 can be between approximately 14 to 16 feet in length, thereby small enough to fit into various different available spaces in deployment sites. Sometimes, the trailer 102 can be smaller in length while still including the components and functionality described herein.

Although the trailer 102 is described as housing the drone 108, the trailer 102 can also be configured to house multiple drones 108. The trailer 102 further may include multiple doors 200, deployment ramps 246, and/or landing pads 251 to allow for the multiple drones 108 to operate simultaneously and/or at different times.

The door(s) 200 can be remotely-operated and/or automated doors configured to open and close to allow movement of the drone 108 between the trailer 102 and a surrounding environment. The door(s) 200 can be automatically controlled by the controller 110, such as in response to receiving location information from the drone 108 indicating that the drone 108 is returning from flight and approaching the trailer 102 (e.g., within some threshold distance of the trailer 102). As another example, the door(s) can be remotely controlled by the remote computer system 104, described further in reference to FIG. 2B. For example, a relevant user can remotely monitor the trailer 102 and the components therein. During the remote monitoring, the user may decide to perform a flight with the drone 108, and thus generate controls at the remote computer system 104 that are transmitted to the controller 110 for execution.

The processor 202 can be any type of processing device and/or group of processing devices, which can be configured to perform one or more of the operations described herein. In some implementations, the processor 202 can be part of the controller 110. The processor 202 can sometimes be part of the controller 110.

The controller 110, as described herein, can be configured to perform various operations to maintain and operate the components of the trailer 102. The controller 110 can, for example, execute instructions at predetermined time intervals (e.g., every day, every 12 hours, once a week) to perform drone flights. For example, the controller 110 can include a pre-flight check software module 204, an ambient conditions software module 206, and/or a scheduling software module 208.

The pre-flight check software module 204 can be configured to perform one or more checks to ensure that the drone 108 is ready to fly and that it is safe to fly the drone 108. For example, the module 204 can receive signals from the sensors 230A-N, such as motion data from one or more proximity sensors 239 and/or one or more safety and security sensors 237. The module 204 can process those signals to determine whether people or other objects (e.g., vehicles, animals, trees, bushes, garbage) are nearby the trailer 102 and thus can be endangered by movement of the components of the trailer 102 and flight of the drone 108. The module 204 can additionally or alternatively receive image data (e.g., images, videos) from the camera(s) 224 of an area surrounding the trailer 102. The module 204 can process the image data to determine whether any objects are nearby and thus can be endangered. If the module 204 does not detect any objects that can be endangered, then the module 204 can determine that pre-flight checks have been satisfied.

The ambient conditions software module 206 can also perform one or more pre-flight checks related to weather and other current and/or upcoming ambient conditions. For example, the module 206 can assess weather information based on processing signals received from the sensors 230A-N, such as one or more microclimate tracking devices 232, one or more wind sensors 234, and/or cloud coverage sensors 236. The module 206 can determine whether, according to the weather information, it will be safe to fly, land, and/or takeoff during one or more time periods (e.g., a current time period, future time periods). The module 206 can implement one or more machine learning models and/or artificial intelligence (AI) algorithms to make such determinations.

As an illustrative example, the module 206 can determine whether and how much it is raining, wind speeds, cloud visibility, temperature changes, or any combination thereof to determine feasibility and safety of flying the drone 108. The module 206's evaluation of the weather information can be transmitted to the scheduling software module 208.

In some implementations, the module 206 can be configured to perform checks against predetermined limits, which can sometimes vary based on a type of drone and/or manufacturer of trailer. The predetermined limits can be automatically checked prior to launching by the module 206. The predetermined limits can include, but are not limited to, wind speed, GPS condition, weather conditions, precipitation rates, etc. Sometimes, one or more additional checks can be performed by relevant users, in addition to the predetermined limits that are automatically checked by the module 206. For example, the relevant users can perform manual checks and validations prior to launch that include, but are not limited to, airspace, flight notifications, enhanced weather data such as visibility and cloud ceiling.

The scheduling software module 208 can be configured to automatically generate flight schedules, charging schedules, and/or schedules for performing other operations with the components of the trailer 102 based on a variety of assessments performed by the controller 110 and data/signals received from the components of the trailer 102 and/or at least the remote computer system 104. For example, the module 208 can schedule drone charging operations based on amount of sunlight and/or availability of stored battery power. The module 208 can schedule one or more flights when weather conditions are agreeable for flight and/or while solar panels are configured to collect solar power. One or more other schedules can also be determined and/or modified by the module 208.

The power supply system 210 can be configured to obtain, store, and provide power to the components of the trailer 102, thereby making the trailer 102 self-sustaining for extended periods of time (e.g., 5 days without sunlight, 7 days of backup power). The system 210 can include batteries 212A-N, solar panels 214A-N, and/or panel tracks 216A-N.

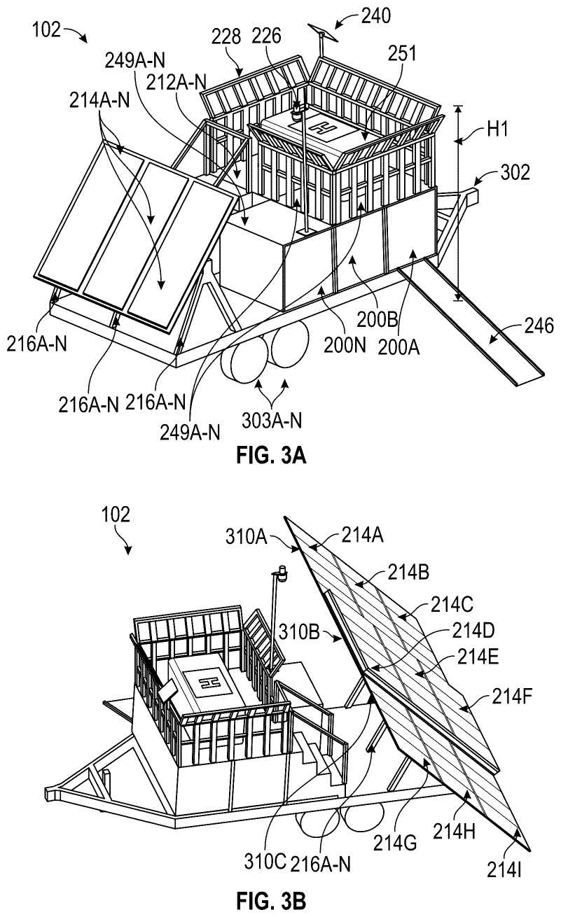

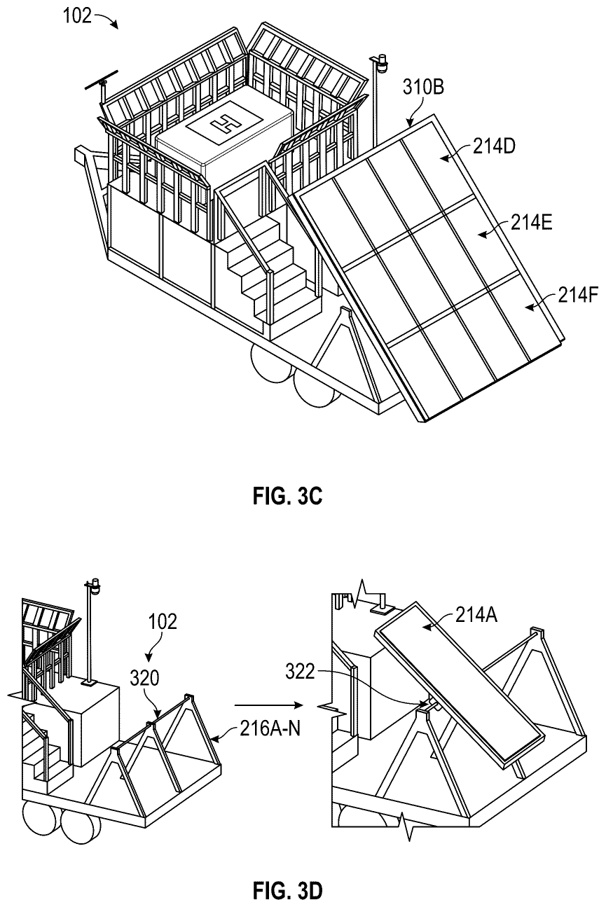

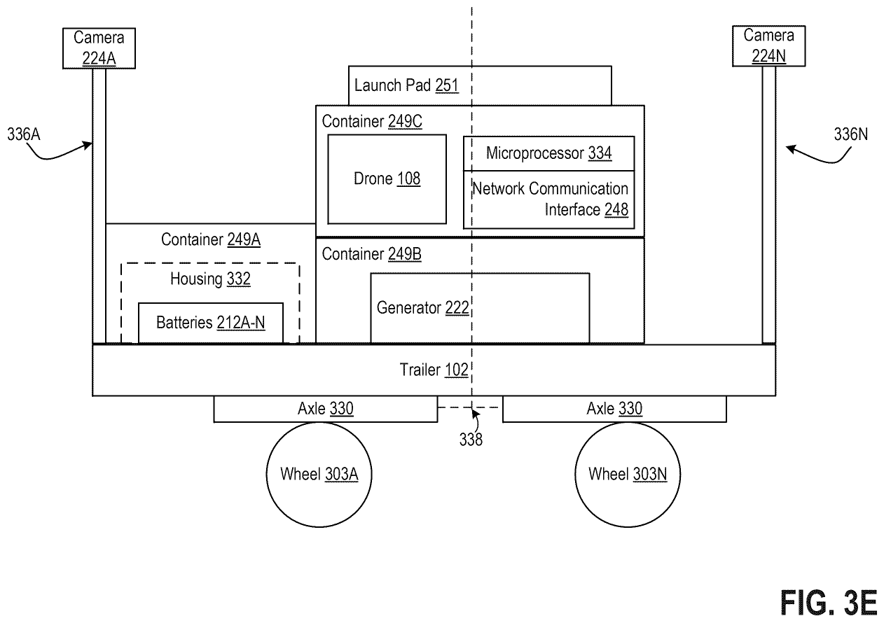

The batteries 212A-N can be onboard or otherwise enclosed in the trailer 102, such as in one or more weather-tight storage containers. As a result, the batteries 212A-N can be isolated from a surrounding environment and external factors (e.g., weather conditions). Sometimes, for example, the batteries 212A-N can be maintained within one or more of the containers 249A-N that are illustrated in FIG. 3A. The batteries 212A-N can then be accessible via the respective doors(s) 200 of the containers 249A-N they are stored within. In yet some implementations, the batteries 212A-N can be stored within a plastic housing inside one of the containers 249A-N. This configuration can be easily accessible by a relevant user, should the batteries 212A-N need to be manually powered on and/or replaced.

The batteries 212A-N can, in some implementations, be solar batteries and/or lithium ion batteries (e.g., 100 amperes), which can allow the batteries 212A-N to enter lower charge states than other types of batteries (e.g., the batteries 212A-N can have a 0-10% discharge range instead of having to maintain at or above a 20% discharge range). In some implementations, the configuration and usage of the batteries 212A-N can allow for 5 days of 12 hours per day of flight time (e.g., with the drone 108 flying for 30 minutes and charging for 45 minutes after every flight). The batteries 212A-N can be configured to maintain solar energy that is collected using the solar panels 214A-N.

In some implementations, the batteries 212A-N can be charged through a battery-to-solar charging and maintenance system (e.g., the battery power storage system 242). The batteries 212A-N can be connected to such charging system, which can also be connected to the solar panels 214A-N to feed power back into the batteries. For example, solar power can be transmitted from the solar panels 214A-N to an inverter of the batter power storage system 242, which can convert voltage of the solar power into a DC signal. The system 242 can then transmit the DC signal to the batteries 212A-N. Similarly, power can be drawn from the batteries 212A-N, into the inverter of the system 242, and converted into an AC signal. The AC signal can be transmitted to other components of the trailer 102, such as the drone 108 or other robots that are maintained by/at the trailer 102. In some implementations, the system 242 (or the controller 110 or another microprocessor on the trailer 102) can control an automatic transfer switch to flip between automatically turning the generator(s) 222 on or off, based on weather conditions throughout the day and available battery power. By the end of the day, it can be desired to have the batteries 212A-N charged to a threshold level, but if the batteries 212A-N do not reach the threshold level, the system 242 can automatically flip on the generator(s) 222 to power components such as the drone 108.

The charging system can also include a power distribution sub-system (e.g., the power supply management system 244), which can provide for outputting the power from the batteries 212A-N to the drone 108 and other components of the trailer 102 where needed. The battery charging system can be configured to monitor and limit charge rates, balance out battery output, and connected through the network(s) 106 (e.g., Internet) to provide battery status to a relevant user (e.g., through a mobile and/or Internet application at their respective mobile device). The charging system can utilize solar-battery charging and management technology that may similarly be used for solar-battery home backup power systems.

In some implementations, the batteries 212A-N can be charged or recharged via power from the solar panels 214A-N and/or the generator(s) 222 (e.g., electric switch). The batteries 212A-N may be heavy in weight and thus can be positioned, on the trailer 102, over an axel (e.g., wheels 303A-N in FIG. 3A).

The system 110 can include a plurality of solar panels 214A-N attached thereto and/or attached to moveable panel tracks 216A-N. In some implementations, one or more of the solar panels 214A-N can be 500 watts each. In an illustrative example configuration, two of the solar panels 214A-N can be 500 watts each. Sometimes, 3 solar panels 214A-N can be 500 watts each. The solar panels 214A-N can be arranged in a variety of configurations, as shown and described in reference to FIGS. 3A, 3B, 3C, and 3D. In one example configuration, the system 210 can include 8 solar panels 214A-N, arranged in a rectangular-shape. 2 of the solar panels 214A-N can be aligned side-by-side and 2 of the solar panels 214A-N can be vertically stacked above the 2 side-by-side solar panels 214A-N. This set of 4 panels 214A-N can be mounted to a set of the panel tracks 216A-N and attached to a side of the trailer 102. Another set of 4 panels 214A-N can be similarly arranged and mounted to a second set of the panel tracks 216A-N on an opposite side of the trailer 102. As another illustrative example, the trailer 102 can include 3 solar panels 214A-N, which can be arranged side-by-side. Refer to FIG. 3A. As yet another example, the trailer 102 can include 9 solar panels 214A-N, arranged similarly to the 8 solar panel 214A-N configuration. Refer to FIGS. 3B and 3C. Other configurations of the solar panels 214A-N are also possible. Sometimes, the solar panels 214A-N can be arranged along a same plane (e.g., 45 degree angle/tilt). As yet another example, the configuration can include 2 solar panels 214A-N that can be positioned side-by-side in a portrait orientation. As another example, the configuration can include 3 solar panels 214A-N that can be positioned side-by-side in a landscape orientation.

The solar panels 214A-N can be manually tilted by relevant users during setup of the trailer 102 at a site. Sometimes, the trailer 102 can be parked facing south such that the solar panels 214A-N have preferred exposure to sunlight throughout the day. Tilt adjustments can vary based on weather conditions, time of year, latitude on earth, and/or a geographic location/region of the site. Sometimes, the panels 214A-N can be automatically tilted, such as by the controller 110. Once on site the panels 214A-N can be tilted up at an appropriate angle (e.g., determined by a computer system, controller, and/or human). The panel 214A-N's tilt mechanism can include a hand crank and/or a manual operation with a notch/pin hole plate that can permit a relevant user to select a desired setting angle.

The panel tracks 216A-N can be configured to mount the panels 214A-N to the trailer 102. The panel tracks 216A-N can be moved into various positions to allow the panels 214A-N to be stored and used. In the above example of the 8 solar panels 214A-N, each of the panels 214A-N can be mounted to respective panel tracks 216A-N. While the trailer 102 is being transported to a site location and/or is in storage, the tracks 216A-N can retract towards or into the trailer 102 such that the mounted panels 214A-N are in a storage configuration (and thus not extending outwards towards the sky or sunlight more generally). Sometimes, the tracks 216A-N can be configured to allow the panels 214A-N to extend outwards from the trailer 102 once the trailer 102 is parked at the site location. In an illustrative example, due to the trailer 102 size, only 2 panels 214A-N can be extended out from each side of the trailer 102, such as while the trailer 102 is being transported to the site location. During transport, the panels 214A-N can be tipped flat. Once at the site location, 2 additional panels 214A-N can be extended out via the tracks 216A-N on each side of the trailer 102 to have a 4 panel wide and a 4 panel stacked configuration.

The HVAC(s) 118 can be configured to activate and deactivate to heat and/or cool one or more of the components of the trailer 102. The controller 110 can receive temperature signals from one or more of the components in the trailer 102 (and/or from the sensors 230A-N) indicating operational temperatures of the components. The controller 110 can process the temperature signals to determine whether any of the components are operating too cool or too hot (based on one or more predetermined operational conditions associated with each of the respective components). The controller 110 can then operate the HVAC(s) 118 accordingly. In some implementations, one or more of the components of the trailer 102 can have ventilation systems built therein. For example, the batteries 212A-N can include ventilation systems that naturally and automatically allow for hot air to be expelled from an area of the trailer 102 housing the batteries 212A-N and for cold air to be let into the area.

The optional energy grid connection system 220 can be configured to allow the components of the trailer 102 to attach directly to energy grid components and/or systems. Such connection can extend a power supply lifetime of at least the batteries 212A-N, further improving self-sustainability of the trailer 102. Sometimes, the system 220 can be configured and used to recharge the batteries 212A-N of the trailer 102 once the trailer 102 is removed from the site location.

The optional generator(s) 222 can be configured to provide backup power and/or boost charging capacity in the event that the power supply system 210 fails/malfunctions and/or has no more power to dispense to components while the trailer 102 is deployed at the site location. The generator(s) 222 can be gas, diesel, and/or hydrogen. Sometimes, the power for the generator(s) 222 can vary based on the trailer 102 and/or a truck/vehicle that pulls the trailer 102 (e.g., a diesel truck can pull the trailer 102, which results in the generator(s) 222 being diesel-powered). In an illustrative example, the generator(s) 222 can be a 2,000 watt generator, which can be used to power the drone 180 and related drone components described herein for approximately or at least 1,000 watts at peak. In some implementations, the generator(s) 222 can be a 4,000 watt generator, which can allow for all components on the trailer 102 to operate at maximum load for at least a predetermined period of time. For example, during a week of no solar energy, a generator 222 powered by a 20 gallon tank of fuel can be sufficient to charge the batteries 212A-N, deplete the batteries 212A-N, and then recharge the batteries 212A-N multiple times to power components on the trailer 102 for that week, such as the drone 108. As another example, the generator 222 can be powered by a 30 gallon tank.

The camera(s) 224 can be any time of imaging device that can be mounted to the physical structure of the trailer 102. For example, the camera(s) 224 can be mounted on a pole that is attached to a portion of the trailer 102. The camera(s) 224 can include a security camera. In some implementations, the trailer 102 may include one camera 224, which can have a 360 degree view around the trailer 102. As another example, the trailer 102 can include multiple cameras 224, such as a camera positioned at each corner and/or along each side or edge of the trailer 102. The camera(s) can be manually controlled (e.g., by a relevant user) and/or automatically (by the controller 110). For example, the trailer 102 can include a first camera 224 on a front side of the trailer 102 and a second camera 224 on the back side of the trailer 102. The first and second cameras 224 can provide for surveillance of a surrounding area. Sometimes, the trailer 102 can include an additional camera 224, which can be configured to scan the sky. Images from the additional camera 224 can be transmitted to the controller 110 and used by the controller 110 to determine whether the sky is free of potential conflict for a safe deployment of the drone 108.

In some implementations, the camera(s) 224 can be a pan-tilt-zoom (PTZ) camera, which can be configured to capture image data (e.g., videos, still images) of an area surrounding the trailer 102, components external the trailer 102, including but not limited to the drone 108, etc. The image data can be transmitted to the controller 110 and processed by the controller 110 to determine whether the trailer 102 is secure and/or safe. The image data can also be used by components such as the pre-flight check software module 204, which can process the image data to ensure that the area surrounding the trailer 102 is free of objects to allow for a safe takeoff and/or landing of the drone 108 at the trailer 102. As another example, the ambient conditions software module 206 can process the image data to determine weather conditions and whether it is safe to fly despite the weather conditions. Sometimes, the controller 110 can more generally process the image data to determine and adjust controls of the drone 108, such as takeoff, landing, flight, charging, etc.

The light(s) 226 can be mounted to the physical structure of the trailer 102, similarly to the camera(s) 224. The light(s) 226 can serve as a warning or security light, which can be automatically illuminated and/or configured to flash when drone operations are occurring. For example, the controller 110 can execute instructions to cause the light(s) 226 to illuminate when the drone 108 has left the trailer 102 and is in flight. The controller 110 can execute instructions to cause the light(s) 226 to flash or strobe when the drone is taking off, landing, and/or otherwise nearby, thereby alerting any nearby objects of the drone 108's movements. In some implementations, the controller 110 can execute instructions to cause the light(s) 226 to automatically turn off once the drone 108 is inside the trailer 102. Various other controls can be performed to use the light(s) 226. In some implementations, the trailer 102 may not include the light(s) 226, since the drone 108 may have one or more lights.

The railing(s) 228 and be built into or otherwise on top of the trailer 102 to satisfy one or more safety regulations and/or requirements. The railing(s) 228 can be any type of handrail and/or fencing boundary that can satisfy fall protection requirements. In some implementations, if the trailer 102 height does not exceed some threshold height for the fall protection requirements, then the trailer 102 may not include the railing(s) 228. Rather than setting up a fence perimeter around the trailer 102 itself, the railing(s) 228 configured to the trailer 102 can enclose the drone 108 and/or the landing pad(s) 251, thereby protecting such components from being accessed by unauthorized people and/or objects.

The trailer 102 can include various sensors 230A-N attached to one or more locations of the physical structure of the trailer 102. The sensors 230A-N can include, but are not limited to, microclimate tracking devices 232, wind sensors 234, cloud coverage sensors 236, safety and security sensors 237, and/or proximity sensors 239. Any of the sensors can generate signals that can be processed and used by components of the controller 110 to perform operations with respect to the other components of the trailer 102. In brief, the sensors 232, 234, and 236 can provide weather-related signals to the controller 110, which can be used to accurately determine weather conditions at the site location. Sometimes, the safety and security sensors 237 may be the same as or similar to the camera(s) 224. Sometimes, the proximity sensors 239 (e.g., motion sensors) can be the same as or similar to the safety and security sensors 237 and/or the camera(s) 224.

The trailer may include one or more stabilization jacks 238 for leveling the trailer 102 on any type of surface at the site location. In some implementations, a stabilization jack 238 can be positioned at each corner of the trailer 102. Various other configurations are also possible.

The antenna system 240 and include one or more components such as a C2 antenna and/or an ADSB-in receiver. The C2 (command and control) antenna can supplement a built-in radio system in the trailer 102 to enable longer range operations and/or alternative radio control methodologies (e.g., 915 MHz, SILVUS RADIOs, LTE). The ADSB, Automatic Dependent Surveillance-Broadcast, receiver can provide situational awareness and reporting of cooperative aircraft locations to a pilot or other relevant user to ensure flight safety. A private in-field sensor or multiple of such sensors can be used to cover blind spots in reporting data and/or unanticipated downtime.

More specifically, the ADSB is an FAA-required system for aircrafts operating in controlled airspace. The ADSB can include an aircraft-based transmitter and a network of ground-based receivers. The aircraft transmitter can provide other pilots and Air Traffic Control with aircraft position, altitude, heading, speed, etc. The ADSB can be used to ensure proper space/clearance exists between other aircraft in the area and can act as a supplement to Air Traffic Control's radar and other sensor systems. The ADSB receiver installed in or connected to a UAV system as described herein can allow a pilot and drone to “see” other ADSB cooperative aircrafts in the area. This provides the pilot with situational awareness of the area and supports the need to yield right of way to manned aircrafts. Sometimes, one or more ground based radar systems in a location of a drone, or a ground based camera system, can be used in combination with the ADSB to visually located aircrafts in that location. Such systems can also be integrated through the drone's ground control station software to feed data to a map display for drone flight and control (e.g., an aircraft detected by radar or camera can show as a plane icon on a map that is used for controlling the drone when in flight).

The battery power storage system 242 can be configured to control battery usage, management, and storage for the batteries 212A-N of the power supply system 210, as described above. For example, the system 242 can manage incoming power and amperage/rates to charge the batteries 212A-N. Incoming power can originate from the solar panels 214A-N, the generator(s) 222 and/or a connection to a grid 252 via the energy grid connection system 220 (e.g., an electrical outlet plug in). The system 242 also can balance voltages of the batteries 212A-N to ensure battery health. The system 242 can manage output power as to not overdraw the batteries 212A-N leading to damaged chemistry and/or reduced performance. Sometimes, the system 242 can be an Internet-connected device, that can automatically report to relevant users information such as battery life, charging information, maintenance alerts, etc. In some implementations, the system 242 can be part of the controller 110. Sometimes, the system 242 can be part of the power supply system 210.

The power supply management system 244 can be configured to control usage, management, and storage of power by the power supply system 210, as described above. In some implementations, the system 244 can be part of the controller 110. Sometimes, the system 244 can be part of the power supply system 210. Sometimes, the battery power storage system 242 and the power supply management system 244 can be a same system that serves dual functionality of monitoring intake of energy/power and monitoring output of energy/power. The system 244 can provide for management of power output. For example, the system 244 can ensure that the batteries 212A-N are not drawing too low in power to cause them damage, ensuring voltages and/or amperage levels are consistent and correct, and/or shutting off power when faults or battery capacity reach predetermined critical levels. As another example, the power supply management system 244 can include one or more microprocessors that can be configured to control charging and discharge of the batters 212A-N. In some implementations, the trailer 102 may include only 1 controller, such as the controller 110, which can include microprocessors that can be configured to perform the operations and processes described throughout this disclosure.

The deployment ramp 246 can be positioned proximate the door(s) 200 to allow for the drone 108 or other components to be loaded onto and out of the trailer 102. The ramp can be manually installed and/or extended at time of setting up the trailer 102 on site. The weather tight door 200 that the ramp 246 leads to would be automatically and/or remotely controlled. This would allow a ground-based robotics systems to live in the trailer 102 and be deployed in addition to or in lieu of the drone 108. The ramp 246 can be approximately 2 feet wide and approximately 8 feet long. The ramp 246 can be grated and/or made with a slip resistant material to combat effects of rain, snow, ice, or other external factors that can impact traction of the drone 108, the ground-based robotics systems, and/or other components housed in the trailer 102.

The network communication interface 248 can be configured to provide wireless communication between components of the trailer 102, including the drone 108 and one or more systems that can be remote from the trailer 102. The network communication interface 248 can include, for example, satellite internet connection, cellular service, 5G, LTE, and/or other types of internet connections. Such connection(s) can allow the components of the trailer 102 to communicate with each other in a self-sustaining way. More particularly, the network communication interface 248 can utilize a bonded failover network switch with LTE/5G cellular data as a backup failsafe/failover network in the event of issues with a satellite internet receiver of the trailer 102 (a primary source of connection for the trailer 102). An internet switch of the network communication interface 248 can provide an Ethernet connection to a WIFI router, which can also provide a local WIFI network for devices to connect to (such as the drone 108, the camera(s) 224, the battery power storage system 242, the power supply management system 244, etc.). In some implementations, if any of the Internet sources described herein are lost while the drone 108 is flying, the drone 108 can have a failsafe capability to automatically return to the trailer 102 and land. The drone 108 would not launch again until the Internet connection has been restored and/or human intervention has occurred to ensure restoration of the Internet connection via the network communication interface 248.

As an illustrative example, the drone 108 can communicate with a base station, such as the remote computer system 104, via the network communication interface 248 of the trailer 102, and the network communication interface 248 can use satellite internet connection to communicate directly with the base station. As another example, the drone 108 can communicate to the trailer 102 via its built-in radio link (e.g., 2.4/5.8 GHz) and the trailer 102 can communicate to the Internet via the Ethernet cable to a network switch and/or connection to the WIFI network, as provided by the network communication interface 248. The Internet connection and/or another local wireless network can be used to provide communication between components on the trailer 102, such as the drone 108, the cameras 224, the battery power storage system 242 (e.g., and inverters that are part of the system 242), and/or the power supply management system 244.

The optional fire suppression system 250 can be housed on the trailer 102 for use in case of emergencies, where one or more components of the trailer 102 may malfunction, overheat, or otherwise cause a fire. The system 250 can be passive, which can be self-activated when a fire is detected. In some implementations, the trailer 102 can be made up of multiple weather tight compartments 249A-N, as shown and described further in reference to FIG. 2C. Each weather tight compartment can include at least one passive fire protection system, which can provide automatic, passive, and initial fire containment upon initial ignition. This passive fire protection system can advantageously have no moving parts and no maintenance required, thereby supporting the overall goal of the trailer 102 being self-sustaining for extended periods of time (e.g., months).

The landing pad(s) 251 can be positioned on one or more surfaces of the trailer 102 to allow for takeoff and/or landing of the drone 108 (refer to FIG. 3A). For example, the drone 108 can be housed in a weather tight compartment on the trailer 102 (such as one or more of the containers 249A-N) and a top surface of this compartment can include the landing pad 251. The compartment can be any type of housing, box, compartment, or structure that is designed for maintaining a UAV, such as the drone 108. In some implementations, when the trailer 102 is set up on site, a relevant user can identify an emergency, alternate landing zone within approximately 100 feet of the trailer 102, which the drone 108 could use if something goes wrong with the compartment for housing the drone 108 and/or the door(s) 200 of the compartment for housing the drone 108. Refer to FIG. 3A for further discussion.

FIG. 2B is a system diagram of components that self-sustaining trailers 102A-N can communicate with. The trailers 102A-N, the remote computer system 104, one or more energy grids 252, and one or more third party computer systems 254 can communicate with each other over the network(s) 106. As described above, the network communication can include satellite, 5G, and/or LTE. All data sources described herein can come into a network switch device (such as the network communication interface 248 of the trailer 102) and can feed Internet via Ethernet cables to various other devices and/or supply Internet to a WIFI router to create a wireless network for communication amongst the devices, components, and/or systems of at least the trailer 102. Optionally, drones 108 may communicate with the remote computer system 104, the energy grids 252, and/or the third party computer systems 254 via the network(s) 106).

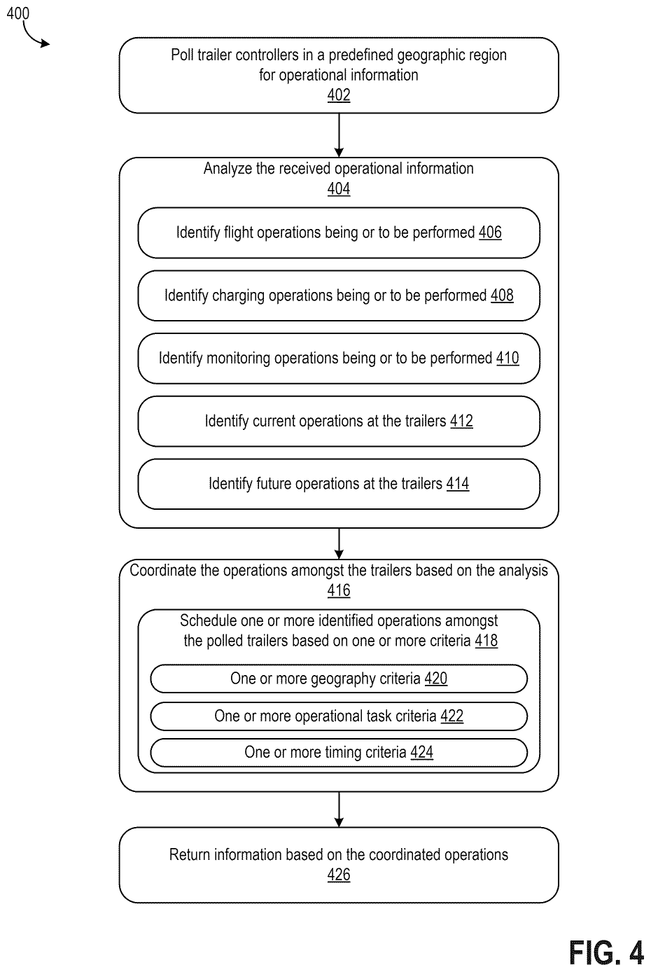

One or more of the trailers 102A-N can also communicate with drones 108 over a local network(s) 280. The local network(s) 280 can be established by the network communication interface 248 of each of the trailers 102A-N, as described in reference to FIG. 2A. The trailers 102A-N can also communicate with each other, such as over the local network(s) 280 and/or the network(s) 106, in order to coordinate operations. Operations can be coordinated to ensure that the drones 108 are safely taking off, landing, and/or in flight without interfering with each other or causing accidents. The operations can also be coordinated to ensure that a fleet of drones 108 can be deployed at same, similar, or different times, and used to survey or image an expanse of a surrounding area (where some of the drones 108 flight paths or surveyed zones may or may not overlap for redundancy purposes). The coordination can occur via communication of the controller 110 of each of the trailers 102A-N with each other. Refer to FIG. 4 for further discussion about coordinating the trailers 102A-N. Refer to FIG. 2A for further discussion about the components of each of the trailers 102A-N.

Each drone 108 can include one or more processors 268, a controller 270, one or more cameras 272, one or more sensors 274, a power supply system 276, and a network communication interface 278. In brief, the processor(s) 268 can be configured to perform operations or otherwise execute instructions that may be generated by and received from the controller 110 of one or more of the trailers 102A-N.

The controller 270 of the drone 108 can be configured to execute the instructions generated and transmitted by the controller 110 of the one or more trailers 102A-N. In some implementations, the processor(s) 268 can be part of the controller 270. The controller 270 can execute instructions including but not limited to takeoff and touchdown, emergency landing on site or at a trailer other than the trailer from which the drone 108 originated, charging, storage, image capture, sensor capture, etc.

The camera(s) 272 can be attached to the drone 108 and used to image an area in which the drone 108 is in flight. The camera(s) 272 can capture images and/or videos, which can be transmitted back to the controller 110 of the corresponding trailer 102 in real-time or near real-time. Sometimes, the controller 270 of the drone 108 can transmit captured image data once the drone 108 is within a predetermined range of the corresponding trailer 102 and/or the drone 108 has returned to the trailer 102 and is charging or otherwise in storage (e.g., not in flight). For example, the image data can be transmitted to the controller 110 of the corresponding trailer 102 using a fast local and private network that is established by the network communication interface 248 of the trailer 102, as described in reference to FIG. 2A. In some implementations, the controller 270 of the drone 108 can transmit the captured image data or a portion thereof to the remote computer system 104, the energy grids 252, the third party computer systems 254, and/or one or more other trailers 102A-N over the network(s) 106. Such components can use the captured image data to survey the imaged area and make relevant determinations about the surveyed area.

The sensor(s) 274 can include any type of sensor described herein, including proximity sensors, motion sensors, weather sensors, security sensors, etc. The sensor(s) 274 can continuously collect signals and transmit those to the controller 270 of the drone 108, which can then transmit the signals to the controller 110 of the corresponding trailer 102 (or a remote computer system over the network(s) 106). For example, the sensor(s) 274 can collect proximity data indicating closeness of the drone 108 to objects such as trees, rocks, the trailer 102, etc., which can be transmitted to the controller 110 of the corresponding trailer 102 and used to determine landing operations for the drone 108.

The power supply system 276 can be configured to provide power to components of the drone 108 while the drone 108 is in flight or otherwise operating. The drone 108 can include one or more batteries as part of the system 276. For example, the drone 108 can have 2 batteries installed. The batteries can be swapped out by a human operator at predetermined time intervals, such as every 3 months, as part of a preventative maintenance plan for the drone 108. The batteries can be provided and specified by a manufacturer of the drone 108. The trailer 102 (or a weather tight compartment on the trailer 102 for housing the drone 108) can also include one or more backup batteries built in to provide the drone 108 with enough power to land and/or be recovered in a total power loss emergency scenario.

When the drone 108 is housed in the corresponding trailer 102, the power supply system 276 of the drone 108 can be charged or recharged by components of the trailer 102. The power supply system 276 may also include one or more sensors configured to detect power level of the system 276, and transmit such information to the controller 110 of the corresponding trailer 102. Using the detected power level, the controller 110 can determine whether the drone 108 has to be routed back to the trailer 102 for charging or whether the drone 108 shall undergo an emergency landing, such as at another of the trailer 102A-N. In some implementations, the drone 108 can be programmed to fly for 30 to 35 minutes, then charge at the corresponding trailer 102 for approximately 40 to 45 minutes, before flying again. Such a schedule for flight and charging can ensure that the drone 108 does not fly when its power levels are less than some predetermined power level threshold.

The network communication interface 278 can be configured to provide wireless communication between the drone 108, its components, and other system components described in FIG. 2B. Refer to the network communication interface 248 in FIG. 2A for further discussion about such wireless communication.

The remote computer system 104 can be any type of computing system that can be remote from the trailers 102A-N. The remote computer system 104, for example, can be associated with an enterprise or organization that is using one or more of the trailers 102A-N to survey, image, etc. an area of interest to the enterprise/organization. As an illustrative example, the remote computer system 104 can be a base station or otherwise associated with the base station. The remote computer system 104 can include one or more processors 256, a controller 258, a network communication interface 260, a trailer operations software module 262, a drone control software module 264, and/or an emergency response software module 266.

In brief, the processor(s) 256 can be configured to perform operations and/or execute instructions at the remote computer system 104. Similarly, the controller 258 can be configured to execute instructions that are generated by components of the remote computer system 104. The controller 258 of the remote computer system 104 can also communicate with at least the controller 110 of each of the trailers 102A-N via the network(s) 106 to provide and receive information. The information received at the controller 258 can be used by the controller 258 to monitor operations at each of the trailers 102A-N and/or the drones 108. This information may also be used by the controller 258 to determine one or more additional or override operations at the trailers 102A-N and/or the drones 108, as described further below.

The network communication interface 260 can be configured to provide wireless and/or wired connections between the components of the remote computer system 104 and other system components over the network(s) 106.

The trailer operations software module 262 can be configured to monitor activities/operations performed at one or more of the trailers 102A-N. As described above, the controller 110 of the respective trailer 102 can transmit information about the operations being performed to the remote computer system 104. The transmitted information can include sensor signals indicating power levels of the power supply system 210 of the trailer 102, power or charge levels of the drone 108, ambient/weather conditions surrounding the trailer 102, image data of an area surrounding the trailer 102, etc. The transmitted information may also indicate instructions that are generated by the controller 110 of the trailer 102 and executed by components of the trailer 102, including but not limited to instructions to: cause the door(s) 200 to open or close, cause the light(s) 226 to activate or deactivate, cause the power supply system 210 to collect, store, and/or release energy, perform one or more pre-flight checks, determine one or more ambient conditions and/or weather information, and/or schedule operations performed at the trailer 102 and/or flights of the drone 108.

Sometimes, the software module 262 can generate instructions to override one or more of the operations that are determined and/or performed by the components of the trailer 102. For example, a relevant user can review the information received from the trailer 102 and determine that a flight should still occur, despite the upcoming weather conditions identified by the controller 110 of the trailer 102. The user can input instructions at the software module 262 to cause the drone 108 to take flight, which can then be automatically transmitted to the controller 110 of the trailer 102 for execution. The user can also input instructions to build and/or modify the drone 108's flight schedules and other operational schedules for the trailer 102. In some implementations, the software module 262 can automatically generate instructions to override the operations of the trailer 102 based on comparing the received information against sets of rules and/or predetermined thresholds.

The drone control software module 264 can generate instructions to override one or more drone control operations that can be determined by the controller 110 of the trailer 102. Similar to the software module 262, the relevant user can review received information from the trailer 102 (or information transmitted from the drone 108 to the remote computer system 104 via communication established by the trailer 102) about the drone control operations, and decide whether to override, modify, and/or create any drone control operations. User input provided at the software module 264 can then be transmitted to the controller 110 of the trailer 102 for execution, or transmitted directly to the controller 270 of the drone 108 via the network communication established by the trailer 102. Similar to the software module 262, the software module 264 can also automatically analyze the received information, compare the information against predetermined rules and/or thresholds, and generate or update the drone control operations accordingly.

The emergency response software module 266 can generate instructions to be executed by the controller 110 of the trailer 102 in the event that an emergency is detected at or near the trailer 102. Similar to the software module 262, the relevant user can review the received information from the trailer 102 using the software module 266 to determine whether an emergency is detected. If the emergency has already been detected and components of the trailer 102, such as the controller 110, are performing automated checks and responses, then the relevant user can review and monitor the performance of the automated checks and responses. The software module 266 can include additional manual and/or automated checks for emergency response and security/safety to be executed. User input provided at the software module 266 can be transmitted to the controller 110 of the trailer 102 for automatic execution, such as controlling the fire suppression system 250 at the trailer 102.

The energy grids 252 can include any type of grid, facility, and/or system that can collect, provide, and/or retain energy. Sometimes, the power supply system 210 of one or more of the trailers 102A-N can be recharged and/or charged using power from the energy grids 252. The energy grids 252 may also include respective computing systems, which can be configured to transmit relevant information about energy collection and/or consumption to one or more of the system components. In some implementations, the energy grid 252 supplying the network(s) 106 can be a 120V outlet supplied for a network switch and/or WIFI router of the network communication interface 248 of the trailer 102. The energy grid power can be fed from a power distribution system of the batteries 212A-N (e.g., the power supply management system 244). Energy from the grid 252 can be used as a small power supply to power one or more necessary components of at least the trailer 102 and/or to provide Internet to one or more devices, components, and/or systems that communicate with the trailer 102.

The third party computer systems 254 can be any type of computing system described herein, which can receive and provide relevant information amongst the system components of FIGS. 2A and 2B. The third party computer systems 254 can, in some implementations, include mobile and/or computing devices of the relevant users associated with the base station. In such examples, the third party computer systems 254 can present information received from the trailer 102 and/or the drone 108 in one or more graphical user interface (GUI) displays. Using the presented information, the relevant users can monitor activities of the trailer 102 and/or the drone 108, and generate and/or modify operations being performed by the trailer 102 and/or the drone 108 (similarly to the remote computer system 104).

FIG. 2C is an illustrative system diagram of the self-sustaining trailer 102 having weather tight containers 249A, 249B, and 249C for housing components depicted in FIG. 2A. In this illustrative example of the trailer 102, the trailer 102 includes 3 containers 249A, 249B, and 249C. In some implementations, the trailer 102 can include additional or fewer containers. Moreover, the trailer 102 is depicted in FIG. 2C as having particular components stored/maintained within each of the containers 249A, 249B, and 249C. It shall be understood that any other combination of components may be stored within each of the containers 249A, 249B, 249C, or other containers in other configurations of the trailer 102.

Referring to FIG. 2C, the container 249A is configured to provide for battery storage, the container 249B is configured to provide power supply and an electronics enclosure for the trailer 102, and the container 249C is configured to provide storage for an optional robot 282. One or more other components can be mounted onto the trailer 102 but outside of the containers 249A-C. Any of the other components can be mounted onto the trailer 102 with some separation from each other to allow for improved fire protection and/or HVAC control systems. For example, the one or more other components that can be mounted on the trailer 102 but outside of the containers 249A-C can include, but is not limited to, the door(s) 200, the solar panels 214A-N, the panel tracks 216A-N, the camera(s) 224, the light(s) 226, the railing(s) 228, the sensors 230A-N, the stabilization jack(s) 238, the antenna system 240, the deployment ramp 246, the landing pad(s) 251, and/or the optional drone 108. Refer to FIG. 3A for further discussion about the containers 249A-C and the other components mounted directly onto the trailer 102.

The container 249A for battery storage can include the batteries 212A-N, the HVAC(s) 218, the optional generator 222, the battery power storage system 242, and the optional fire suppression system 250. The container 249A can optionally include one or more fewer, other, or additional components. In some implementations, the HVAC(s) 218 can include a heater that can be configured to provide heat around the batteries 212A-N, especially when external ambient temperatures drop below a predetermined threshold level. Similarly, when the temperatures drop below the predetermined threshold level, a drone/robot and other components described herein that operate with the drone/robot can automatically move into a standby mode. The drone/robot and its corresponding components may shift back into a working mode based on a determination or detection that the temperature exceeds the predetermined threshold level. In yet some implementations, the HVAC(s) 218 can include one or more fans that can be mounted along a roof of one or more of the containers 249A-N and configured to circulate air therein. The containers 249A-N may include inlets near the roof to allow for hot air to be pulled out from the containers 249A-N and for cooler air to be brought into the containers 249A-N.

The container 249B for power supply and electronics can include the optional energy grid connection system 220, the power supply management system 244, the network communication interface 248, and another optional fire suppression system 250. The container 249B can optionally include one or more fewer, other, or additional components. For example, although not depicted in FIG. 2C, the container 249B can optionally house the controller 110, the processor(s) 202, or a combination thereof.

The container 249C can store the optional robot 282 and the deployment ramp 246. In some implementations, the container 249C may not include the deployment ramp 246 but rather can be connected to the deployment ramp 246 that is external the container 249C and attached to the trailer 102 (refer to FIG. 3A). The robot 282 can be a ground-based robot that can be configured to automatically exit the container 249C via the ramp 246 and perform operations/surveillance on the ground or surrounding the trailer 102's site. The robot 282 can communicate with any of the components described herein and provide data or other information that can be used to control any of the components of the trailer 102 and/or the drone 108. The container 249C can optionally include one or more fewer, other, or additional components.

FIGS. 3A, 3B, 3C, and 3D illustrate an example self-sustaining trailer 102, described further in reference to at least FIG. 2A, for housing a drone. In FIG. 3A, the trailer 102 includes 3 solar panels 214A-N arranged in a vertical orientation on respective panel tracks 216A-N. This configuration of the solar panels 214A-N can be lightweight and simple, which can be advantageously used for short durations of trailer deployment at a site location. Refer to FIG. 3B for another configuration of the solar panels 214A-N, which can be used for longer durations of trailer deployment at the site location.

The trailer 102 further includes doors 200A, 200B, and 200N, each of which can open into a weather-tight storage container, group of containers, and/or singular containers 249A-N for housing a respective drone or other components of the trailer 102, as described further in reference to FIG. 2C. The trailer 102 can include the ramp 246, which can be aligned with one or more of the doors 200A-N. The ramp 246 may not be moved between the doors 200A-N. Instead, in some implementations, a ramp can be positioned in front of each of the doors 200A-N that will be opened and/or closed while the trailer 102 is deployed on site.

The trailer 102 can include the landing pad 251 positioned on top of the weather-tight storage container(s) 249A-N. At least the batteries 212A-N of the trailer 102 can be stored/maintained securely within the weather-tight storage container(s) 249A-N. For example, one or more controllers and/or generators of the trailer 102 can be stored within the same weather tight container (e.g., compartment). The drone 108 can be housed within another, separate weather tight container (e.g., compartment). In some implementations, the drone 108 container can also store one or more of the batteries 212A-N, the controllers, and/or the generators.

Various other components of the trailer 102 described in reference to FIG. 2A can be stored within the container(s) 249A-N, as described in reference to FIG. 2C. The railing(s) 228 can extend around at least the top surface of the container(s) 249A-N, thereby enclosing the landing pad 251. The light(s) 226 can include a pole that is attached to any desired portion of the trailer 102, such as on the top surface of the container(s) 249A-N. The Antenna system 240 can also be attached to any desired portion of the trailer 102. In the example of FIG. 3A, the antenna system 240 can be attached to a portion of the railing 228. Attaching the antenna system 240 to the railing 228 can beneficially prevent the antenna system 240 from being tampered with by any external objects, forces, and/or potentially bad actors/users. Sometimes, the antenna system 240 can be attached to a corner portion of the railing 228 to ensure that it remains elevated at an optimal location for signal strength, view of the sky, and avoidance of generating data blindspots. Such a location can also be beneficial to ensure the antenna system 240 is far enough away from the launching pad 251 so as to not interfere with operations of the drone 108.

The trailer 102 can include a hitch 302, which can allow for the trailer 102 to be coupled to a vehicle, such as a truck. The truck can then haul or otherwise move the trailer 102 to and from site locations.

The trailer 102 further can include wheels 303A-N, which can allow for the trailer 102 to be transported to and from site locations. The wheels 303A-N as well as the stacking of components on the trailer 102 (see the container(s) 249A-N, with the railing 228, light(s) 226, and antenna system 240 stacked thereon shown in FIG. 3A) can cause the trailer 102 to have a height H1 from a ground/floor level. The height H1 can allow for components of the trailer 102 to remain out of reach of people, potentially malicious actors, and/or other objects that may be surrounding or otherwise passing by the trailer 102 at the site location(s). The height H1 can also ensure that the trailer 102 and its components may be protected from debris or other potential safety hazards that can exist on the ground/floor level surrounding the trailer 102. The trailer 102 can have a clearance height of approximately 12 feet. The clearance height can be taller, in some implementations. In some implementations, one or more of the components illustrated in FIG. 3A may be designed to be folded for storage to minimize potential height constraints when transporting the trailer 102 and deploying the trailer in the field. For example, the antenna system 240 and/or one or more poles (not depicted) for maintaining cameras and/or lights can be folded during transportation and during trailer deployment in the field.

In FIG. 3B, the example trailer 102 includes 9 solar panels 214A, 214B, 214C, 214D, 214E, 214F, 214G, 214H, and 214I. Each of the solar panels 214A-I can be include one or more segments. As an illustrative example, each of the solar panels 214A-I can include 4 segments. The solar panels 214A-I can include additional or fewer quantities of segments.

The panels 214A-I can be arranged on respective trays 310A, 310B, and 310C, which can extend out into an open position when the trailer 102 is parked at a site location and contract into a closed position when the trailer 102 is in storage or being transported (refer to FIG. 3C). The trays 310A-C can be attached to the panel tracks 216A-N to allow such functionality and also tilting of the panels 214A-I on each of the trays 310A-C.

In the illustrative example of FIG. 3B, the trailer 102 is parked at the site location and the trays 310A-C have been extended out into the open position. Here, the solar panels 214A, 214B, and 214C can be a first set that is attached to the tray 310A. The solar panels 214D, 214E, and 214F can be a second set that is attached to the tray 310B. The solar panels 214G, 214H, and 214I can be a third set that is attached to the tray 310C. Although the trays 310A and 310C may extend out laterally from the tray 310B, each solar panel of the three sets of solar panels (214A, 214B, and 214C as one set, 214D, 214E, and 214F as the second set, and 214G, 214H, and 214I as the third set) can be arranged in a vertical orientation (e.g., solar panels are stacked on top of each other in each set of solar panels).

In FIG. 3C, the trailer 102's solar panels are in a closed position. The trailer 102 can be in storage and/or may be transported to a site location. Refer to FIG. 3B for further discussion about the trailer 102 when the solar panels are in an open position. Here, only the solar panels 214D, 214E, and 214F are visible on the tray 310B because the solar panels 214A, 214B, and 214C on the tray 310A and the solar panels 214G, 214H, and 214I on the tray 310C (refer to FIG. 3B) have been slid back into place behind the tray 310B for storage/transportation purposes.

FIG. 3D illustrates the trailer 102's panel tracks 216A-N having a round cross bar 320. A solar panel, such as the illustrative solar panel 214A, can be mounted onto the round cross bar 320 via a mounting mechanism 322 of the solar panel. As a result, the solar panel can then be tilted along the round cross bar 320 to one or more desired angles in the open position and/or the closed position. For example, during transport, the solar panels described herein can be tilted flat, which can minimize wind resistance. As another example, once at a site location, the solar panels can be tilted up to a desired and/or appropriate angle (which, as described herein, can be determined based on time of year and/or latitude of the earth). The panels can be tilted via a hand crank and/or a manual operation with a notch/pin hole plate, either of which can be operated by a relevant user. The hand crank and the notch/pin hole plate can both allow the user to select a desired setting angle for the solar panels.

FIG. 3E illustrates another example setup of the trailer 102 described herein. The trailer 102 can include an axle 330 and the wheels 303A-N. In some implementations, the trailer 102 can be a dual-axle trailer. In other implementations, the trailer 102 can be a single-axle trailer. The trailer 102 can also include one or more additional axles, which can depend on a total weight that is being sustained by the trailer 102. The trailer 102 can also include the containers 249A-C. The container 249A can be configured to maintain the batteries 212A-N. The container 249A can be positioned mostly over the axle 330, such as mostly over the wheel 303A, to balance a weight of the batteries 212A-N across the trailer 102. Sometimes, the batteries 212A-N can be further maintained in a housing 332 inside of the container 249A. The housing 332 can be a plastic housing.

The containers 249B and 249C can also be relatively centered over or at a midpoint 338 of the axle 330 of the trailer 102. This placement can be beneficial to balance weight of components stored therein (e.g., weight of heaviest components on the trailer 102). The container 249B can maintain the generator 222. The container 249C can maintain the drone 108 and/or other components that are used for operating the drone 108. For example, the container 249C can also house a microprocessor 334 and/or the network communication interface 248. The microprocessor 334 can be similar to controllers described herein and can be configured to perform the disclosed operations. The launch pad 251 can also be positioned on top of the container 249C. The launch pad 251 can be positioned at a highest point on the trailer 102. Sometimes, any of the containers 249A, 249B, and 249C may not be stacked on top of each other. One or more of the containers 249A, 249B, and 249C can be positioned side-by-side across the trailer 102 bed (e.g., such that each of the containers 249A, 249B, and 249C are positioned relatively along a center point or midpoint of the trailer 102 and/or the axle 330.

The trailer 102 can further include cameras 224A and 224N, which can be affixed to respective poles 336A and 336N. In some implementations, the cameras 224A and 224N can be attached to highest points on the trailer 102, such as a top of the container 249A and a top of the container 249C so that the poles 336A and 336N may not be part of the trailer 102. Regardless, the cameras 224A and 224N can be arranged such that they have vantage points that are highest on the trailer 102. The cameras 224A and 224N can be configured to capture images of a surrounding environment for purposes of surveillance described herein. The cameras 224A and 224N can be positioned at opposing sides or ends of the trailer 102, such as a front side and a back side of the trailer 102 and/or left side and a right side of the trailer 102.

FIG. 4 is a flowchart of a process 400 for coordinating operations amongst a group of self-sustaining trailers housing drones. The process 400 can be performed to ensure that an entire designated area is being covered by a fleet of drones provided by the group of trailers and that efforts and/or operations may not be duplicated amongst the trailers and the drones. For example, the process 400 can be performed to schedule one or more drones amongst the fleet to fly while one or more other drones amongst the fleet are charging. If live monitoring is required of the area, then the process 400 can allow for the area to always be monitored by at least one of the drones amongst the fleet while other operations are being performed amongst the group of trailers. Coordination of the operations amongst the trailers can be based on a variety of factors, including but not limited to drone controls, geography, time, and other operational tasks of the trailers and/or the drones.

The process 400 can be performed by a controller of any one or more of the group of trailers. The process 400 can additionally or alternatively be performed by a remote system, such as the remote computer system 104 described in reference to at least FIGS. 1 and 2B. For illustrative purposes, the process 400 is described from the perspective of a controller.

Referring to the process 400, the controller can poll one or more trailer controllers in a predefined geographic region for operational information (block 402). The controller can identify trailers within a predefined range of the controller to poll (e.g., within some predefined radius of the controller). Sometimes, the controller can ping or otherwise transmit signals to the trailer controllers that are already in network communication with the controller. The controller can continuously poll the trailer controllers. The controller can poll the trailer controllers at one or more time intervals, such as once a day, twice a day, every 4 hours, every 2 hours, every 15 minutes, etc. Sometimes, the controller can poll the trailer controllers for operational information associated with a current time. The controller can additionally poll the trailer controllers for operational information associated with one or more future times (e.g., a next 4 hours, a next day, etc.).

The operational information polled for in block 402 can include schedules and other data indicating what operations and/or tasks are being (or will be) performed at the respective trailers. Such schedules and data can include, as non-limiting examples, schedules for when to charge drones, schedules for when to fly the drones, schedules for when to collect and store energy, etc.

In block 404, the controller can analyze the received operational information. For example, the controller can identify flight operations being or to be performed in block 406. The controller can identify charging operations being or to be performed in block 408. The controller can identify monitoring operations being or to be performed in block 410. Any of the determinations in blocks 406, 408, and 410 can be performed with regards to one or more predetermined periods of time. The controller can identify current operations at the respective trailer(s) in block 412. The controller can identify future operations at the respective trailer(s) in block 414. The controller can identify the future operations using one or more rulesets, algorithms, artificial intelligence (AI) algorithms, and/or machine learning models.

Based on the analysis, the controller can coordinate the operations amongst the trailers (block 416). For example, the controller can schedule one or more of the identified operations amongst the polled trailers based on one or more criteria (block 418). The one or more criteria can include, but is not limited to, one or more geography criteria (block 420), one or more operational task criteria (block 422), and/or one or more timing criteria (block 424).

In block 426, the controller can return information based on the coordinated operations. Returning the information can include generating and transmitting instructions to each of the trailer controllers indicating what operations are to be performed at the respective trailer. Returning the information can include storing information about the operational changes determined by the controller in a data store. The stored information can later be accessed and retrieved for execution and/or additional analysis/processing. As another example, returning the information can include transmitting information about the operational changes to a computing device of a relevant user associated with the trailers. The user can review the transmitted information in GUI displays at their respective devices and decide whether or not to implement the operational changes.

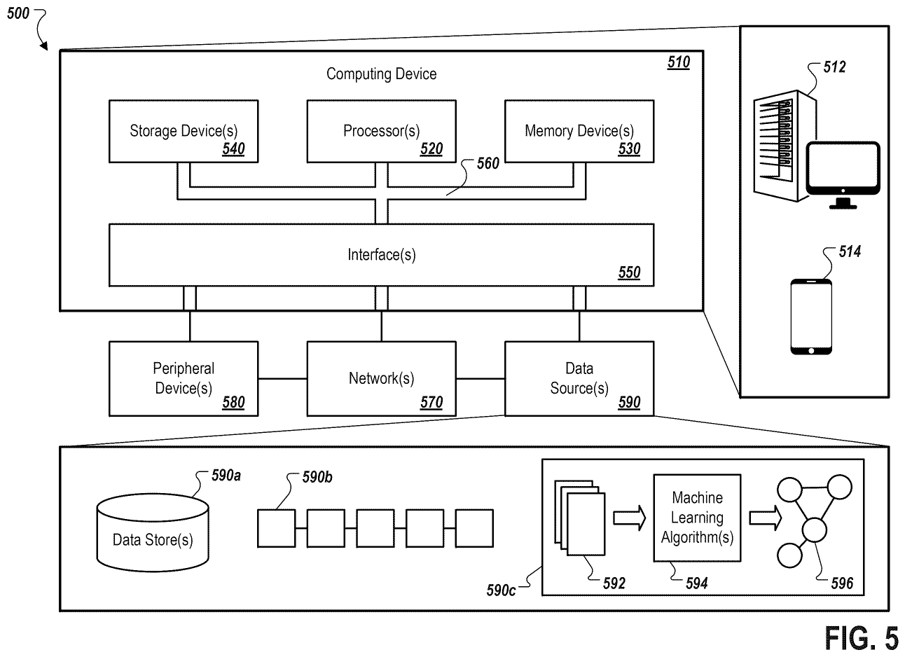

FIG. 5 is a schematic diagram that shows an example of a computing system 500 that can be used to implement the techniques described herein. The computing system 500 includes one or more computing devices (e.g., computing device 510), which can be in wired and/or wireless communication with various peripheral device(s) 580, data source(s) 590, and/or other computing devices (e.g., over network(s) 570). The computing device 510 can represent various forms of stationary computers 512 (e.g., workstations, kiosks, servers, mainframes, edge computing devices, quantum computers, etc.) and mobile computers 514 (e.g., laptops, tablets, mobile phones, personal digital assistants, wearable devices, etc.). In some implementations, the computing device 510 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 510, and an entire system can be made up of multiple devices communicating with each other. For example, the computing device 510 can be part of a computing system that includes a network of computing devices, such as a cloud-based computing system, a computing system in an internal network, or a computing system in another sort of shared network. Processors of the computing device (510) and other computing devices of a computing system can be optimized for different types of operations, secure computing tasks, etc. The components shown herein, and their functions, are meant to be examples, and are not meant to limit implementations of the technology described and/or claimed in this document.

The computing device 510 includes processor(s) 520, memory device(s) 530, storage device(s) 540, and interface(s) 550. Each of the processor(s) 520, the memory device(s) 530, the storage device(s) 540, and the interface(s) 550 are interconnected using a system bus 560. The processor(s) 520 are capable of processing instructions for execution within the computing device 510, and can include one or more single-threaded and/or multi-threaded processors. The processor(s) 520 are capable of processing instructions stored in the memory device(s) 530 and/or on the storage device(s) 540. The memory device(s) 530 can store data within the computing device 510, and can include one or more computer-readable media, volatile memory units, and/or non-volatile memory units. The storage device(s) 540 can provide mass storage for the computing device 510, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 550 can include various communications interfaces (e.g., USB, Near-Field Communication (NFC), Bluetooth, WiFi, Ethernet, wireless Ethernet, etc.) that can be coupled to the network(s) 570, peripheral device(s) 580, and/or data source(s) 590 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 550 can include a control interface that receives commands from an input device (e.g., operated by a user) and converts the commands for submission to the processors 520. The interface(s) 550 can include a display interface that includes circuitry for driving a display to present visual information to a user. The interface(s) 550 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 570 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 510 can communicate with the peripheral device(s) 580, the data source(s) 590, and/or other computing devices over the network(s) 570. In some implementations, the computing device 510 can directly communicate with the peripheral device(s) 580, the data source(s), and/or other computing devices.

The peripheral device(s) 580 can provide input/output operations for the computing device 510. Input devices (e.g., keyboards, pointing devices, touchscreens, microphones, cameras, scanners, sensors, etc.) can provide input to the computing device 510 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 510 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 590 can provide data for use by the computing device 510, and/or can maintain data that has been generated by the computing device 510 and/or other devices (e.g., data collected from sensor devices, data aggregated from various different data repositories, etc.). In some implementations, one or more data sources can be hosted by the computing device 510 (e.g., using the storage device(s) 540). In some implementations, one or more data sources can be hosted by a different computing device. Data can be provided by the data source(s) 590 in response to a request for data from the computing device 510 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 590a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 590b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 590c. The machine learning system(s) 590c, for example, can be used to analyze data from various sources (e.g., data provided by the computing device 510, data from the data store(s) 590a, data from the blockchain(s) 590b, and/or data from other data sources), to identify patterns in the data, and to draw inferences from the data patterns. In general, training data 592 can be provided to one or more machine learning algorithms 594, and the machine learning algorithm(s) can generate a machine learning model 596. Execution of the machine learning algorithm(s) can be performed by the computing device 510, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A self-sustainable trailer for deploying an unmanned aerial vehicle (UAV) at a site for an extended period of time, the self-sustainable trailer comprising:
a power supply system configured to generate, store, and provide power to components of the self-sustainable trailer, wherein the power supply system comprises a battery and a plurality of solar panels;
at least one sensor configured to generate signals indicating ambient conditions proximate the self-sustainable trailer;
a railing attached along a perimeter of the self-sustainable trailer, wherein the railing encloses an area where a UAV is configured to take off and touch down;
a network communication interface configured to provide wireless communication amongst components of the self-sustainable trailer and the UAV; and
a controller in communication, via the network communication interface, with the components of the self-sustainable trailer and the UAV, wherein the controller is configured to perform operations comprising:
receiving the signals generated by the at least one sensor;
generating and executing, based on processing the signals, instructions to cause the power supply system to provide power to a power source of the UAV to charge the UAV when the UAV is docked at the self-sustainable trailer;
performing, based on processing the signals, one or more pre-flight checks before the UAV is scheduled to take off from the self-sustainable trailer; and
generating and executing, based on processing the signals, instructions to control the UAV when the UAV is in flight.

2. The self-sustainable trailer of claim 1, wherein the plurality of solar panels comprises 3 solar panels, wherein the 3 solar panels are arranged in a lateral orientation on respective trays, wherein the trays are attached to tracks on a top surface of the self-sustainable trailer.

3. The self-sustainable trailer of claim 1, wherein the at least one sensor comprises a camera attached to a top surface of the self-sustainable trailer and configured to capture image data of an area surrounding the self-sustainable trailer.

4. The self-sustainable trailer of claim 1, wherein the wireless communication is a satellite internet communication.

5. The self-sustainable trailer of claim 1, wherein the UAV is configured to communicate with the remote computer system via the network communication interface of the self-sustainable trailer.

6. The self-sustainable trailer of claim 1, wherein the self-sustainable trailer further comprises a weather-resistant container that houses the network communication interface, the controller, and the UAV, wherein the weather-resistant trailer comprises a door configured to automatically open and close to permit the UAV to enter and exit the weather-resistant container.

7. The self-sustainable trailer of claim 1, wherein the self-sustainable trailer further comprises a generator configured to provide a backup power supply to one or more of the components of the self-sustainable trailer.

8. The self-sustainable trailer of claim 1, wherein performing, based on processing the signals, one or more pre-flight checks before the UAV is scheduled to take off from the self-sustainable trailer comprises determining, based on processing the signals, whether one or more objects are proximate the self-sustainable trailer to obstruct a flight path of the UAV.

9. The self-sustainable trailer of claim 1, further comprising an axle, wherein the components of the self-sustainable trailer are arranged on the self-sustainable trailer proximate a midpoint of the axle.

10. The self-sustainable trailer of claim 1, wherein the operations further comprise modifying, based on processing the signals, a scheduling of operations performed by the components of the self-sustainable trailer.

11. The self-sustainable trailer of claim 10, wherein modifying the scheduling of operations comprises recharging the battery of the power supply system for a predetermined period of time.

12. The self-sustainable trailer of claim 10, wherein modifying the scheduling of operations comprises adjusting a time and duration at which the UAV will be in flight over one or more future time periods.

13. The self-sustainable trailer of claim 1, wherein the operations further comprise transmitting, via the network communication interface, information about operations performed by one or more of the components of the self-sustainable trailer to a remote computer system, wherein, in response to receiving the information, the remote computer system is configured to present the information in a graphical user interface (GUI) display,
wherein the remote computer system is configured to:
receive user input, based on presenting the information in the GUI display, indicating one or more modifications to the operations performed by the one or more of the components of the self-sustainable trailer; and
transmit, via the network communication interface, the user input to the controller of the self-sustainable trailer, wherein the controller is configured to automatically execute instructions to adjust the operations based on the one or more modifications.

14. The self-sustainable trailer of claim 13, wherein the one or more modifications to the operations comprise adjusting a time and duration at which the UAV is charged by the battery of the power supply system.

15. The self-sustainable trailer of claim 1, wherein the power supply system is configurably attached to a top surface of the self-sustainable trailer, wherein the area where the UAV is configured to take off and touch down is stacked on a top surface of the power supply system, and wherein the railing extends along a perimeter of the area on the top surface of the power supply system.

16. A trailer for deploying a UAV at a site for an extended period of time, the trailer comprising:
a power supply system configured to generate, store, and provide power to components of the trailer;
a railing attached along a perimeter of the trailer, wherein the railing encloses an area where a UAV is configured to take off and touch down;
a network communication interface configured to provide wireless communication amongst the components of the trailer; and
a controller in communication, via the network communication interface, with at least the power supply system and the UAV, wherein the controller is configured to monitor, modify, and control one or more operations performed by components of the trailer.

17. The trailer of claim 16, wherein the power supply system comprises a battery.

18. The trailer of claim 16, wherein the power supply system comprises a plurality of solar panels.

19. The trailer of claim 16, further comprising at least one sensor configured to generate signals indicating ambient conditions proximate the trailer.

20. The trailer of claim 16, wherein the railing is attached along a perimeter of the power supply system and the area where the UAV is configured to take off and touch down comprises a top surface of the power supply system enclosed by the railing.
